(19) United States
(12) Patent Application Publication
(10) Pub. No.: US 2026/0095224 A1
(43) Pub. Date: Apr. 2, 2026

(54) Aperiodic CSI Report With Dormant BWP or SCell

(71) Applicant: Apple Inc., Cupertino, CA (US)

(72) Inventors: Haitong SUN, Saratoga, CA (US); Dawei ZHANG, Saratoga, CA (US); Fangli XU, Beijing (CN); Ghaith N HATTAB, San Jose, CA (US); Hong HE, San Jose, CA (US); Hongbo YAN, Vista, CA (US); Ismael GUTIERREZ GONZALEZ, San Jose, CA (US); Jie CUI, San Jose, CA (US); Wei ZENG, Saratoga, CA (US)

(21) Appl. No.: 19/113,794

(22) PCT Filed: Sep. 23, 2022
(86) PCT No.: PCT/CN2022/120970

§ 371 Date: Mar. 20, 2025

(51) Int. Cl. H04B 7/06; H04W 24/10

(52) U.S. Cl. CPC H04B 7/0626; H04W 24/10

(57) ABSTRACT

A user equipment (UE) is configured to receive a secondary serving cell (SCell) configuration indicating a dormant bandwidth part (BWP) and a dormant BWP configuration associating the dormant BWP with a BWP identifier (ID), receive a channel state information (CSI) resource configuration for a measurement resource associated with the BWP ID of the dormant BWP, receive a CSI report configuration for a CSI report, the CSI report configuration indicating the CSI resource configuration for the measurement resource associated with the BWP ID of the dormant BWP and either not handle or ignore at least the CSI resource configuration for the measurement resource associated with the BWP ID of the dormant BWP.

### TECHNICAL FIELD

This application relates generally to wireless communication, and in particular relates to aperiodic CSI report with dormant BWP or SCell.

### BACKGROUND INFORMATION

In 3GPP 5G New Radio (NR), channel state information (CSI) reporting can be configured for a user equipment (UE) by a network cell. The CSI report configuration includes a field for a CSI report type, e.g., periodic, semi-persistent or aperiodic, and fields for measurement resources, e.g., channel measurement resources (CMR) and (optional) interference measurement resources (IMR). The measurement resource configuration includes a field for a bandwidth part (BWP) identifier. Multiple CSI reports can be configured for a UE, e.g., 16 or more. Aperiodic CSI reports can be triggered by the network in a CSI request in downlink control information (DCI). Each codepoint of the CSI request field can be mapped to up to 16 configured aperiodic CSI reports.

In Rel-16 NR, to enhance UE power saving, the dormant BWP and dormant secondary cell (SCell) was introduced. The dormant BWP is configured by the network in a serving cell configuration via dedicated RRC signaling. In the dormant BWP, the UE stops monitoring PDCCH on/for the SCell, but can continue performing other operations, if configured, including periodic and semi-persistent CSI reporting. The network can switch a given BWP to/from dormancy via downlink (DL) signaling, e.g., DCI.

A UE may not expect to perform aperiodic CSI reporting nor measurement on a dormant BWP/SCell. Each CSI request can trigger up to 16 aperiodic CSI reports, and it is possible that some CSI reports are in a non-dormant BWP and other CSI reports are in a dormant BWP. In this scenario, the UE behavior is unclear.

### SUMMARY

Some exemplary embodiments are related to a processor of a user equipment (UE) configured to perform operations. The operations include receiving a secondary serving cell (SCell) configuration indicating a dormant bandwidth part (BWP) and a dormant BWP configuration associating the dormant BWP with a BWP identifier (ID), receiving a channel state information (CSI) resource configuration for a measurement resource associated with the BWP ID of the dormant BWP, receiving a CSI report configuration for a CSI report, the CSI report configuration indicating the CSI resource configuration for the measurement resource associated with the BWP ID of the dormant BWP and either not handling or ignoring at least the CSI resource configuration for the measurement resource associated with the BWP ID of the dormant BWP.

Other exemplary embodiments are related to a user equipment (UE) having a transceiver configured to communicate with a network and a processor communicatively coupled to the transceiver and configured to perform operations. The operations include receiving a secondary serving cell (SCell) configuration indicating a dormant bandwidth part (BWP) and a dormant BWP configuration associating the dormant BWP with a BWP identifier (ID), receiving a channel state information (CSI) resource configuration for a measurement resource associated with the BWP ID of the dormant BWP, receiving a CSI report configuration for a CSI report, the CSI report configuration indicating the CSI resource configuration for the measurement resource associated with the BWP ID of the dormant BWP and either not handling or ignoring at least the CSI resource configuration for the measurement resource associated with the BWP ID of the dormant BWP.

Still further exemplary embodiments are related to a processor of a base station configured to perform operations.

The operations include transmitting to a user equipment (UE) a secondary serving cell (SCell) configuration indicating a dormant bandwidth part (BWP) and a dormant BWP configuration associating the dormant BWP with a BWP identifier (ID), transmitting to the UE a channel state information (CSI) resource configuration for an aperiodic measurement resource and transmitting to the UE a CSI report configuration for a CSI report, the CSI report configuration indicating the CSI resource configuration for the measurement resource, wherein the base station is restricted from configuring the CSI report with the aperiodic measurement resource associated with the BWP ID of the dormant BWP, or expects the UE to either not handle or ignore at least the CSI resource configuration if the measurement resource is associated with the BWP ID of the dormant BWP.

Additional exemplary embodiments are related to a base station having a transceiver configured to communicate with a user equipment (UE) and a processor communicatively coupled to the transceiver and configured to perform operations. The operations include transmitting to a user equipment (UE) a secondary serving cell (SCell) configuration indicating a dormant bandwidth part (BWP) and a dormant BWP configuration associating the dormant BWP with a BWP identifier (ID), transmitting to the UE a channel state information (CSI) resource configuration for an aperiodic measurement resource and transmitting to the UE a CSI report configuration for a CSI report, the CSI report configuration indicating the CSI resource configuration for the measurement resource, wherein the base station is restricted from configuring the CSI report with the aperiodic measurement resource associated with the BWP ID of the dormant BWP, or expects the UE to either not handle or ignore at least the CSI resource configuration if the measurement resource is associated with the BWP ID of the dormant BWP.

Other exemplary embodiments are related to a processor of a user equipment (UE) configured to perform operations. The operations include receiving a secondary serving cell (SCell) configuration indicating a dormant bandwidth part (BWP) and a dormant BWP configuration associating the dormant BWP with a BWP identifier (ID), receiving a channel state information (CSI) resource configuration for a measurement resource associated with the BWP ID of the dormant BWP or a further BWP ID of a non-dormant BWP on the dormant Scell, receiving a CSI report configuration for an aperiodic CSI report, the CSI report configuration indicating the CSI resource configuration for the measurement resource associated with the BWP ID of the dormant BWP or the further BWP ID of the non-dormant BWP on the dormant Scell, receiving a CSI request configuration mapping a CSI request codepoint to a list of aperiodic CSI reports including the aperiodic CSI report, receiving a downlink control information (DCI) including the CSI request codepoint triggering the execution of the list of aperiodic CSI reports and either not handling the triggering, or handling the triggering and dropping at least the aperiodic CSI report including the measurement resource associated with the BWP ID of the dormant BWP or the further BWP ID of the non-dormant BWP on the dormant SCell.

Still other exemplary embodiments are related to a a user equipment (UE) having a transceiver configured to communicate with a network and a processor communicatively coupled to the transceiver and configured to perform operations. The operations include receiving a secondary serving cell (SCell) configuration indicating a dormant bandwidth part (BWP) and a dormant BWP configuration associating the dormant BWP with a BWP identifier (ID), receiving a channel state information (CSI) resource configuration for a measurement resource associated with the BWP ID of the dormant BWP or a further BWP ID of a non-dormant BWP on the dormant Scell, receiving a CSI report configuration for an aperiodic CSI report, the CSI report configuration indicating the CSI resource configuration for the measurement resource associated with the BWP ID of the dormant BWP or the further BWP ID of the non-dormant BWP on the dormant Scell, receiving a CSI request configuration mapping a CSI request codepoint to a list of aperiodic CSI reports including the aperiodic CSI report, receiving a downlink control information (DCI) including the CSI request codepoint triggering the execution of the list of aperiodic CSI reports and either not handling the triggering, or handling the triggering and dropping at least the aperiodic CSI report including the measurement resource associated with the BWP ID of the dormant BWP or the further BWP ID of the non-dormant BWP on the dormant SCell.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary network cell according to various exemplary embodiments.

FIG. 4a shows a portion of a CSI-ReportConfig IE for configuring a CSI report.

FIG. 4b shows the CSI-ResourceConfig IE for configuring a resource set for CSI measurements.

FIG. 4c shows the CSI-AperiodicTriggerStateList IE for configuring a mapping between a CSI request codepoint and a list of aperiodic CSI reports.

FIG. 4d shows the DormantBWP-Config-r16 IE for configuring a dormant BWP.

FIG. 5 shows a diagram for AP-CSI report triggering where at least one of the triggered AP-CSI reports is in the dormant BWP according to various exemplary embodiments.

FIG. 6 shows a diagram for a timeline restriction between the DCI triggering/modifying SCell dormancy relative to the DCI triggering an AP-CSI report according to various exemplary embodiments.

FIG. 7 shows a method for handling an aperiodic CSI report configuration and/or triggering on a dormant BWP according to various exemplary embodiments.

### DETAILED DESCRIPTION

The exemplary embodiments may be further understood with reference to the following description and the related appended drawings, wherein like elements are provided with the same reference numerals. The exemplary embodiments describe operations for restricting the configuration or reporting of an aperiodic channel state information (CSI) report on a dormant bandwidth part (BWP) and/or dormant secondary cell (SCell).

The exemplary aspects are described with regard to a UE. However, the use of a UE is provided for illustrative purposes. The exemplary aspects may be utilized with any electronic component that may establish a connection with a network and is configured with the hardware, software, and/or firmware to exchange information and data with the network. Therefore, the UE as described herein is used to represent any electronic component that is capable of accessing a wireless network and performing CSI operations.

The exemplary aspects are described with regard to the network being a 5G New Radio (NR) network and a base station being a next generation Node B (gNB). However, the use of the 5G NR network and the gNB are provided for illustrative purposes. The exemplary aspects may apply to any type of network that utilizes similar functionalities.

The exemplary embodiments are described with regard to carrier aggregation performed at a 5G NR network and with SCell dormancy configured. However, the use of the 5G NR network is only exemplary. The exemplary embodiments may be modified and/or used with any network that supports carrier aggregation (CA) or a substantially similar functionality in which a plurality of component carriers (CCs) is used, as well as any functionality that utilizes a dormant bandwidth part (BWP) on the SCell. For example, a legacy network such as LTE supports CA functionalities and the exemplary embodiments may be used with such a network.

A dormant bandwidth part (BWP) may be configured for an SCell to enable fast SCell activation. With regard to a particular SCell, a UE and the SCell may be configured in a non-dormant (activated) state, a dormant (activated) state and a deactivated state relative to the connection therebetween. In the non-dormant activated state, the UE may be configured for 1) monitoring of the physical downlink control channel (PDCCH), 2) transmission of sounding reference signals (SRSs), a radio access channel (RACH), a physical uplink shared channel (PUSCH) and a physical downlink shared channel (PDSCH), 3) beam management and CSI measurement, and 4) automatic gain control (AGC). In the dormant state, the UE may be configured for 3) beam management and CSI measurement and 4) AGC, but not for 1) PDCCH monitoring or 2) transmission as described above. In the deactivated state, the UE is not configured for any of the functions 1)-4) described above. It is further noted that periodic CSI reporting is supported in the dormant state, but aperiodic CSI reporting is not supported.

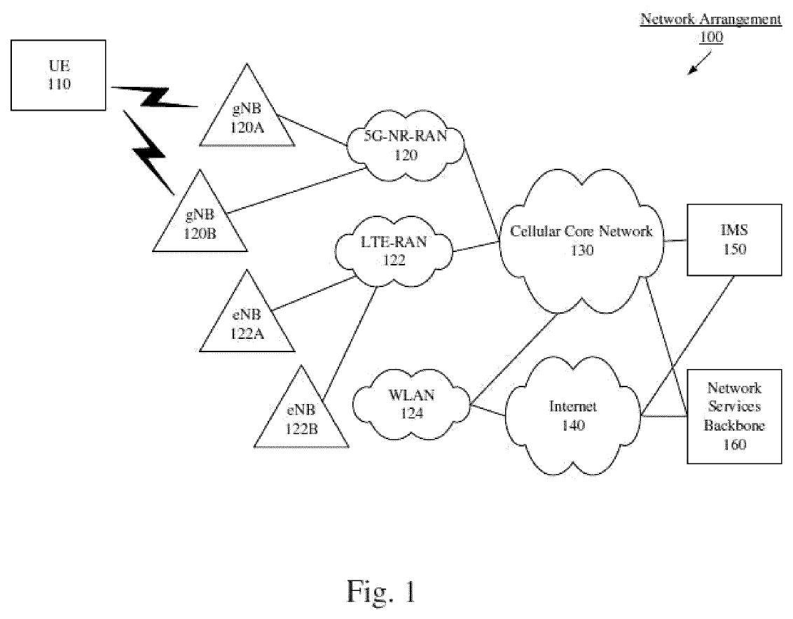

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., a component of a connected car, a mobile phone, a tablet computer, a smartphone, a phablet, an embedded device, a wearable, an Internet of Things (IOT) device, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, Sprint, T-Mobile, etc.) . These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. The gNBs 120A, 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. Reference to two gNB 120A, 120B is merely for illustrative purposes. The exemplary embodiments may apply to any appropriate number of gNBs. Specifically, the UE 110 may simultaneously connect to and exchange data with a plurality of gNBs 120A, 120B in a multi-cell CA configuration or a multi-TRP configuration. The UE 110 may also connect to the LTE-RAN 122 via either or both of the eNBs 122A, 122B, or to any other type of RAN, as mentioned above. In the network arrangement 100, the UE 110 is shown as having a simultaneous connection to the gNBs 120A and 120B. The connections to the gNBs 120A, 120B may be, for example, multi-TRP connections where both of the gNBs 120A, 120B provide services for the UE 110 on a same channel.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

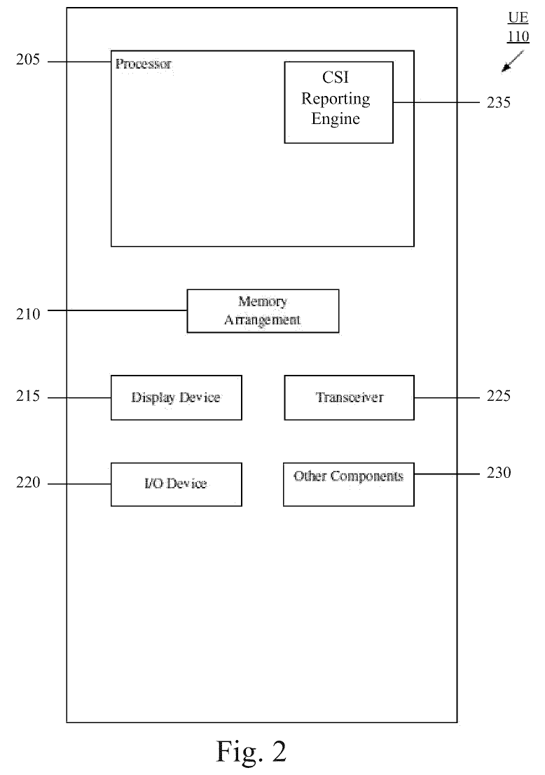

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a channel state information (CSI) reporting engine 235. The CSI reporting engine 235 may perform operations including receiving a CSI report configuration, performing CSI measurements and generating a CSI report. To be described in further detail below, the CSI reporting engine 235 may also determine whether a CSI report configuration is invalid and/or determine to drop certain CSI reports when triggered, e.g., aperiodic CSI reports on a dormant BWP or dormant SCell. The specific implementations for various scenarios will be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

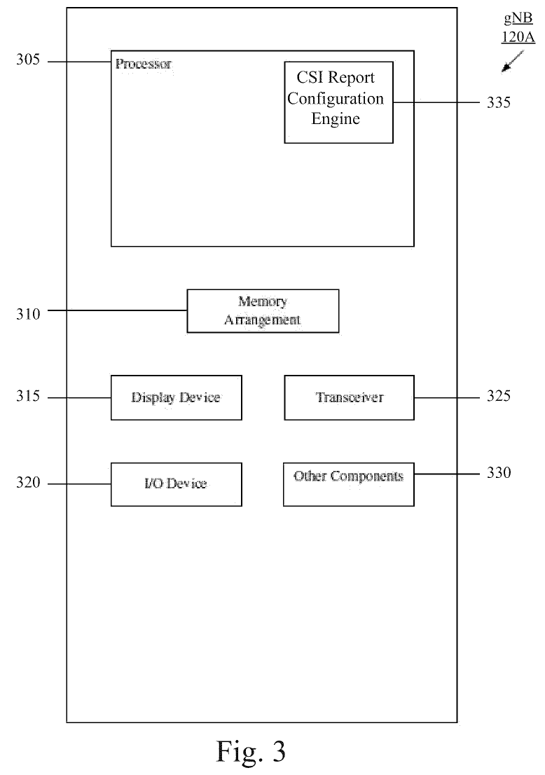

FIG. 3 shows an exemplary network cell, in this case gNB 120A, according to various exemplary embodiments. As noted above with regard to the UE 110, the gNB 120A may represent a cell in a multi-TRP configuration with the UE 110. The gNB 120A may represent any access node of the 5G NR network through which the UEs 110, 112 may establish a connection and manage network operations. The gNB 120A illustrated in FIG. 3 may also represent the gNB 120B.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a CSI report configuration engine 335. The CSI report configuration engine 335 may perform operations including configuring a UE to perform CSI measurements and generate a CSI report for transmission to the gNB. To be described in further detail below, the CSI reporting engine 335 may also determine whether a CSI report configuration is invalid, e.g., aperiodic CSI reports on a dormant BWP or dormant SCell. The specific implementations for various scenarios will be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UEs 110, 112 and any other UE in the system 100, e.g., if the gNB 120A serves as a PCell or an SCell to either or both of the UEs 110, 112. The transceiver 325 may operate on a variety of different frequencies or channels (e.g., set of consecutive frequencies). Therefore, the transceiver 325 may include one or more components (e.g., radios) to enable the data exchange with the various networks and UEs.

In 3GPP 5G NR specification, channel state information (CSI) is reported by a UE to a gNB and may include some or all of the following information: a CSI-RS resource index (CRI), a Rank Indicator (RI), a Precoder Matrix Indicator (PMI), a Layer Indicator (LI), and/or a Channel Quality Indicator (CQI). The CSI may be reported by a physical uplink shared channel (PUSCH), a short physical uplink control channel (PUCCH) or a long PUCCH.

The CSI reporting can be configured for a user equipment (UE) by a network cell. The CSI report configuration includes a field for a CSI report type, e.g., periodic, semi-persistent or aperiodic, and fields for measurement resources, e.g., channel measurement resources (CMR) and (optional) interference measurement resources (IMR). The measurement resources may be used by the UE for performing channel measurements on RS such as NZP-CSI-RS, SSB or CSI-IM.

In 3GPP TS 38.331, the CSI-ReportConfig information element (IE) is used to configure: a periodic or semi-persistent CSI report sent on PUCCH on the cell in which the CSI-ReportConfig is included; or a semi-persistent or aperiodic CSI report sent on PUSCH triggered by DCI received on the cell in which the CSI-ReportConfig is included (in this case, the cell on which the report is sent is determined by the received DCI).

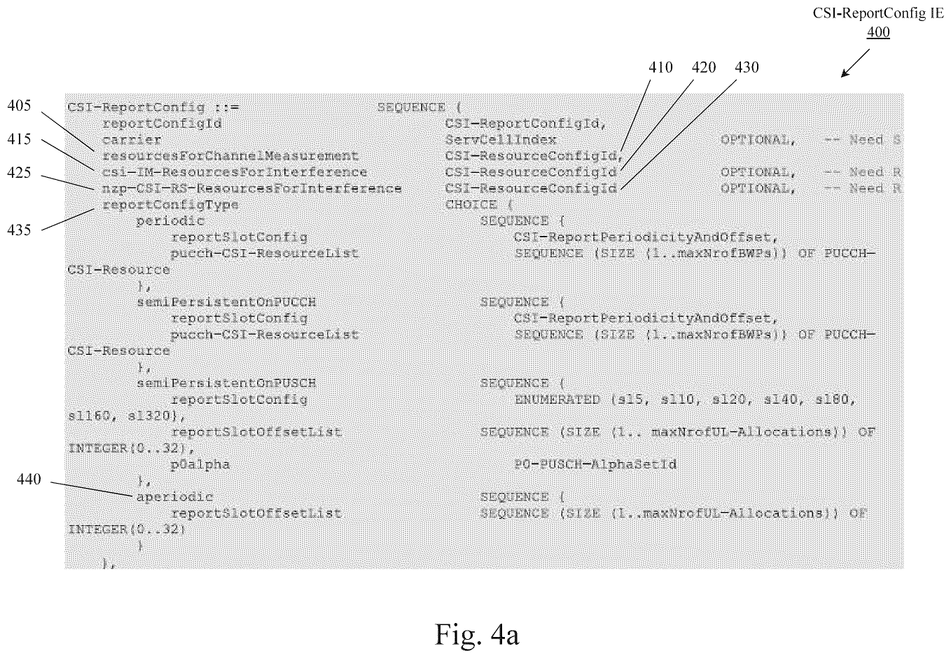

FIG. 4a shows a portion of a CSI-ReportConfig IE 400 for configuring a CSI report. The CSI-ReportConfig IE 400 can configure three possible types of measurement resources: a channel measurement resource (CMR) (field 405 for resourcesForChannelMeasurement); a zero-power interference measurement resource (ZP-IMR) (field 415 for csi-IM-ResourcesForInterference); and a non-zero-power interference measurement resource (NZP-IMR) (field 425 for nzp-CSI-RS-ResourcesForInterference) . The CMR 405 is always configured in the CSI-ReportConfig 400 and has a field 410 for a first CSI-ResourceConfigID associated therewith. The ZP-IMR 415 is optionally configured and has a field 420 for a second CSI-ResourceConfigID associated therewith. The NZP-IMR 425 is optionally configured and has a field 430 for a third CSI-ResourceConfigID associated therewith.

The CSI-ResourceConfigID is associated with and used to identify a CSI resource configuration (CSI-ResourceConfig). The CSI-ResourceConfig IE defines a group of one or more CMR resources, ZP-IMR resources, or NZP-IMR resources.

FIG. 4b shows the CSI-ResourceConfig IE 450 for configuring a resource set for CSI measurements. The CSI-ResourceConfig IE 450 can configure: a CMR resource set (CSI-SSB-ResourceSet 455); a ZP-IMR resource set (CSI-IM-ResourceSet 460); or a NZP-IMR resource set 465 (NZP-CSI-RS-ResourceSet 465). The CSI-ResourceConfig IE 450 further includes a field 470 for a BWP ID on which to perform the CSI measurements and a field 475 for the time domain behavior of the resource configuration (resourceType), e.g., aperiodic, semi-persistent or periodic.

Returning to the CSI-reportconfig IE 400 of FIG. 4a, the type of CSI report is configured in a field 435 for reportConfigType. There are three different CSI report time domain behavior, e.g., CSI report configuration types, including periodic, semi-persistent (semiPersistentOnPUCCH or semiPersistentOnPUSCH) and aperiodic 440. The configured aperiodic CSI report can be triggered by the “CSI request” field in downlink control information (DCI), e.g., DCI format 0_1 or 0_2. Each codepoint of the CSI request field can be mapped to up to 16 configured aperiodic CSI reports based on the operations described below.

FIG. 4c shows the CSI-AperiodicTriggerStateList IE 470 for configuring a mapping between a CSI request codepoint and a list of aperiodic CSI reports. Each codepoint of the DCI field “CSI request” is associated with one trigger state (CSI-AperiodicTriggerState 485). Each trigger state comprises a number of entries in a associatedReportConfigInfoList 490. The list of associated CSI report configurations in CSI-AssociatedReportConfigInfo 495 can include up to a maximum number of report configurations per aperiodic trigger. In current specification, the list can include up to 16 aperiodic CSI reports to which a CSI request codepoint value is mapped.

Upon reception of the value associated with a trigger state, the UE will perform measurement of CSI-RS, CSI-IM and/or SSB (reference signals) and aperiodic reporting on L1 according to all entries for that trigger state.

In Rel-16 NR, to enhance UE power saving, the dormant BWP and dormant secondary cell (SCell) was introduced. The dormant BWP is configured by the network in a serving cell configuration (ServingCellConfig) via dedicated RRC signaling. In the dormant BWP, the UE stops monitoring PDCCH on/for the SCell, but can continue performing other operations, if configured, including periodic and semi-persistent CSI reporting, automatic gain control (AGC), beam management, etc. For each serving cell (other than the SpCell or PUCCH SCell), the network may configure one BWP as a dormant BWP.

The IE ServingCellConfig is used to configure (add or modify) the UE with a serving cell, which may be the SpCell or an SCell of an MCG or SCG. If the serving cell of the ServingCellConfig is an SCell, the field DormantBWP-Config-r16 can provide configuration parameters for a dormant BWP for a dormant SCell.

FIG. 4d shows the DormantBWP-Config-r16 IE 496 for configuring a dormant BWP. The DormantBWP-Config-r16 IE 496 includes a field 497 for associating the dormant BWP (dormantBWP-ID-r16) with a BWP-ID.

The network can switch a given BWP//from dormancy via downlink (DL) signaling, e.g., DCI. There are two methods to indicate the BWP/SCell dormancy. In a BWP switch-based method, a special BWP is configured as the dormant BWP via RRC from the network, as described above. The network uses an L1 (DCI) based indication to switch to/from the dormancy BWP. In a wakeup signal-based method, DCI 2_6 (PDCCH WUS) carries an explicit information field (configured from 0 to 5 bits) to indicate SCell dormancy.

It was agreed in RAN2 that UE is not expected to perform aperiodic CSI reporting nor measurement on dormant BWP/SCell, regardless of the manner or triggering and regardless of whether if it is configured for transmission on a dormant or non-dormant SCell. Each CSI request can trigger up to 16 aperiodic CSI reports, and it is possible that some CSI reports are in a non-dormant BWP and other CSI reports are in a dormant BWP. In this scenario, the UE behavior is unclear.

According to various exemplary embodiments described herein, operations are described for restricting the configuration or reporting of an aperiodic CSI report on a dormant BWP and/or dormant SCell.

In one aspect of these exemplary embodiments, the network is restricted from configuring a measurement resource for an aperiodic CSI report in a dormant BWP. More specifically, if the measurement resource indicated for the aperiodic CSI report is configured in the dormant BWP, the configuration is either invalid or ignored, as described below. The UE receiving such a configuration is not expected to follow or handle the configuration. As described above, three types of measurement resources (CMR resources; ZP-IMR resources, or NZP-IMR resources) can be indicated in the CSI-ReportConfig.

In one embodiment, only the CMR (resourcesForChannelMeasurement) for an aperiodic CSI report configuration is restricted from being configured in the dormant BWP. In this embodiment, it is immaterial whether the IMR (NZP and/or ZP) are configured in the dormant BWP or a non-dormant BWP because the entire CSI report configuration is invalid and will not be handled by the UE.

To provide an illustrative example, referring to the CSI-ReportConfig 400 of FIG. 4a, the reportConfigType 435 may be aperiodic 400 and the resourcesForChannelMeasurement 405 may indicate a CSI-ResourceConfigId 410 for a CSI-ResourceConfig. Referring to the CSI-ResourceConfig IE 450 of FIG. 4b, the field 470 for the bwp-ID of the measurement resource may indicate the bwp-ID of the dormantBWP-ID-r16. The CSI-ResourceConfig 450 in the dormant BWP may be for CMR (csi-SSB-ResourceSetList 460 is indicated) and the resourceType 475 may be aperiodic.

According to the present embodiment, in the aperiodic CSI-ReportConfig 400, the network is restricted from indicating the CSI-ResourceConfigID 410 of a CSI-ResourceConfig 450 indicating the dormant BWP (i.e., the bwp-ID 470 corresponding to the dormantBWP-ID-r16). Such a CSI report configuration, if received by the UE, is invalid and will not be handled by the UE.

In other embodiments, the IMR (ZP-IMR csi-IMResourcesFor Interference and/or NZP-IMR nzp-CSI-RS-ResourcesForInterference) for an aperiodic CSI report are restricted from being configured in the dormant BWP, in addition to the CMR. In these embodiments, if any of the restricted measurement resource (CMR; ZP-IMR and/or NZP-IMR) are configured in the dormant BWP, the entire CSI report configuration is invalid and will not be handled by the UE.

To provide an illustrative example, referring to the CSI-ReportConfig 400 of FIG. 4a, the reportConfigType 435 may be aperiodic 440 and the resourcesForChannelMeasurement 405, the csi-IMResourcesForInterference 415, or the nzp-CSI-RS-ResourcesForInterference 425 may indicate a CSI-ResourceConfigId 410, 420 or 430, respectively, for a CSI-ResourceConfig.

Referring to the CSI-ResourceConfig IE 450 of FIG. 4b, the field 470 for the bwp-ID of the measurement resource may indicate the bwp-ID of the dormantBWP-ID-r16.

According to the present embodiment, in the aperiodic CSI-ReportConfig 400, the network is restricted from indicating the CSI-ResourceConfigID 410, 420 or 430 of a CSI-ResourceConfig 450 indicating the dormant BWP (i.e., the bwp-ID 470 corresponding to the dormantBWP-ID-r16). Such a CSI report configuration, if received by the UE, is invalid and will not be handled by the UE.

It is noted that, in the embodiment described above, even if the associated BWP of CMR (resourcesForChannelMeasurement) is not the dormant BWP, but the associated BWP of IMR (csi-IMResourcesForInterference and/or nzp-CSI-RS-ResourcesForInterference) is the dormant BWP, the entire CSI report configuration is invalid and the UE is not expected to handle such a configuration.

In an alternative embodiment, in this scenario, the CSI report configuration is valid. The UE can follow the CMR configuration in the non-dormant BWP and ignore the IMR that is configured in the dormant BWP.

In another aspect of these exemplary embodiments, UE operations are described for the scenario where the UE receives an RRC configuration/reconfiguration that modifies the dormant BWP after handling previously received aperiodic CSI report configurations.

To provide an illustrative example, the UE may receive an aperiodic CSI report configuration that indicates measurement resources on a first BWP that is not the dormant BWP. Subsequently, the UE may receive a configuration/reconfiguration for the dormant BWP (DormantBWP-Config-r16) that indicates the first BWP as the dormant BWP.

In this embodiment, upon receiving the dormant BWP configuration/reconfiguration, the UE can deactivate the aperiodic CSI report that has the corresponding measurement resources in the dormant BWP. If multiple aperiodic CSI reports indicate the (now dormant) BWP, all these aperiodic CSI reports can be deactivated.

In still another aspect of these exemplary embodiments, rather than applying a restriction to the configuration of the aperiodic CSI report in a dormant BWP, the triggering of the aperiodic CSI report in the dormant BWP can be restricted. In these aspects, UE operations are described for scenarios where an aperiodic CSI request triggered by “CSI request” field in DCI contains more than one aperiodic CSI reports (AP-CSI), where some AP-CSI reports are in the non-dormant BWP, and some AP-CSI reports are in the dormant BWP.

In one embodiment, the UE does not expect to be triggered with an aperiodic CSI report for a dormant BWP. When some triggered AP-CSI reports are in the non-dormant BWP and some triggered AP-CSI reports are in the dormant BWP, the triggering may be invalid and the UE is not expected to handle any of the triggered AP-CSI reports.

In another embodiment, as long as at least one of the triggered aperiodic CSI reports (of a maximum of 16) is in a valid (non-dormant) BWP, the triggering is valid. If none of the triggered aperiodic CSI reports are in the non-dormant BWP the triggering may be invalid (e.g., an error case).

In the scenario where the triggering is valid, and at least one of the triggered AP-CSI reports is in the non-dormant BWP, the following options may be used.

In one option, the UE can drop the whole aperiodic CSI request regardless of whether some of the AP-CSI reports are in the non-dormant BWP. In another option, the UE can drop only the AP-CSI reports in the dormant BWP and still transmits the AP-CSI in the non-dormant BWP.

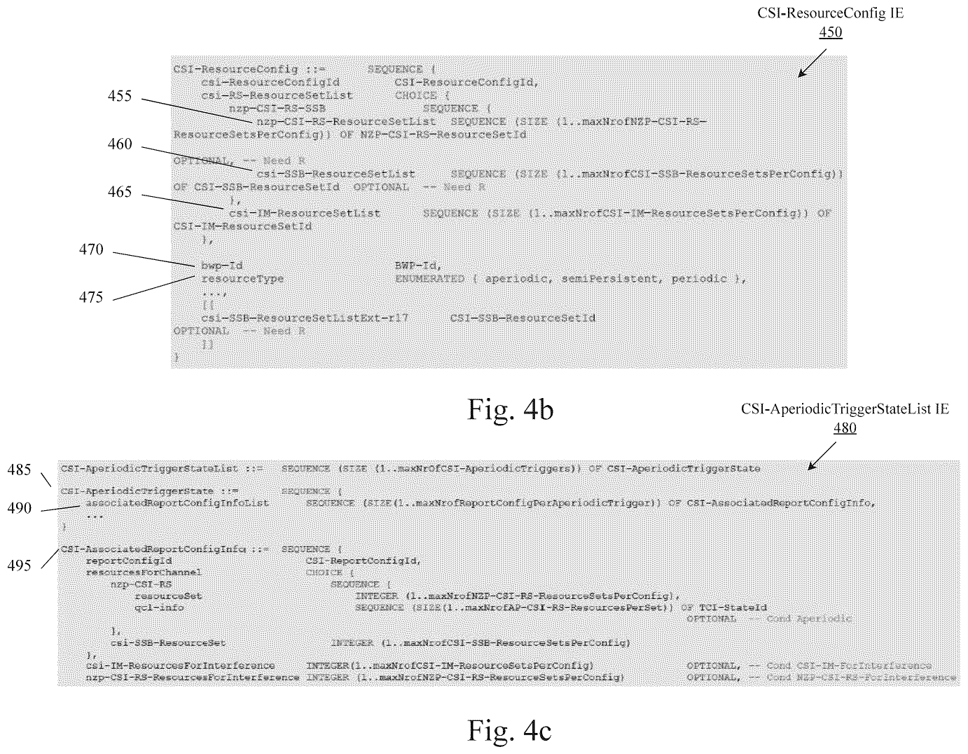

FIG. 5 shows a diagram 500 for AP-CSI report triggering where at least one of the triggered AP-CSI reports is in the dormant BWP according to various exemplary embodiments. In this example, the AP-CSI request 505 is received in a DL DCI and indicates a codepoint value mapping to a list of aperiodic CSI reports. Referring to FIG. 4c, the CSI-AperiodicTriggerStateList IE 470 configures the mapping between a CSI request codepoint and a list of aperiodic CSI reports. In this example, the AP-CSI request 505 indicates a value mapping to four AP-CSI reports, e.g., a first AP-CSI report 510 (AP-CSI report 0), a second AP-CSI report 515 (AP-CSI report 1), a third AP-CSI report 515 (AP-CSI report 2), and a fourth AP-CSI report 520 (AP-CSI report 3).

In this example, the AP-CSI reports 510, 520 are configured in a non-dormant BWP and the AP-CSI reports 515, 525 are configured in the dormant BWP. According to the options described above, if the first option is used, the UE drops the whole aperiodic CSI request including the four AP-CSI reports 510-525. In this option, no CSI report is sent to the network. If the second option is used, the UE drops the AP-CSI reports only in the dormant BWP. In this option, AP-CSI reports 510 and 520 are sent to the network.

In another embodiment, the CSI report omission operations described above can be extended to the dormant SCell. When the SCell is indicated to be in dormancy, all the BWP configured for the dormant SCell are considered to be dormant and the dormant SCell is considered to be inactive.

In this embodiment, AP-CSI reports can be omitted/dropped in any BWP configured for the dormant SCell. Thus, according to the first option discussed above, if any of the AP-CSI reports are triggered for a dormant SCell, the entire triggering can be dropped. In the second option, only the AP-CSI reports triggered for the dormant SCell are dropped.

In still another embodiment, the UE may support the second option discussed above (dropping only triggered AP-CSI reports in dormant BWP/SCell and transmitting AP-CSI reports in non-dormant BWP/SCell) as an optional feature. The default UE behavior (e.g., if this feature is not supported), may correspond to the first option discussed above, where all the triggered AP-CSI reports (including those on non-dormant BWPs/SCells) are dropped. If the UE supports the advanced feature, may drop only the triggered AP-CSI reports in the dormant BWP/SCell and transmit AP-CSI reports in the non-dormant BWP/SCell.

To indicate UE support of this advanced feature, the following options may be used. In a first option, the existing capability csi-TriggerStateNon-ActiveBWP-r16 can be reused, which currently indicates UE support of CSI trigger states containing a non-active BWP. Thus, this capability can be extended to include both UE support of CSI trigger states containing a non-active BWP and UE support of selective AP-CSI report dropping as described above.

In a second option, a new capability can be introduced. The new capability can have a pre-requisite of supporting SCell dormancy and can be included in either feature group (FG) 18-4 and/or FG18-4a. The new capability can be reported as: per UE; per UE with FR1/FR2 differentiation; per UE with licensed/unlicensed differentiation; per UE with NTN/non-NTN differentiation; per band; or per band combination (BC). It is noted that the capability is defined on the cell on which the UE performs the AP-CSI measurement.

In still another aspect of these exemplary embodiments, a timeline restriction is described for the DCI triggering/modifying SCell dormancy relative to the DCI triggering an AP-CSI report. As described above, a BWP can be switched to or from the dormant BWP via an L1 (DCI) based indication or via a wakeup signal (WUS) (DCI 2_6 PDCCH WUS) carrying an explicit information field indicating SCell dormancy.

In this embodiment, the last symbol of the DCI that triggers the SCell dormancy (including either of the above options) shall be no later than the last symbol of the DCI that triggers the AP-CSI report. In the case of PDCCH repetition, the last symbol of the PDCCH candidate that ends later is used.

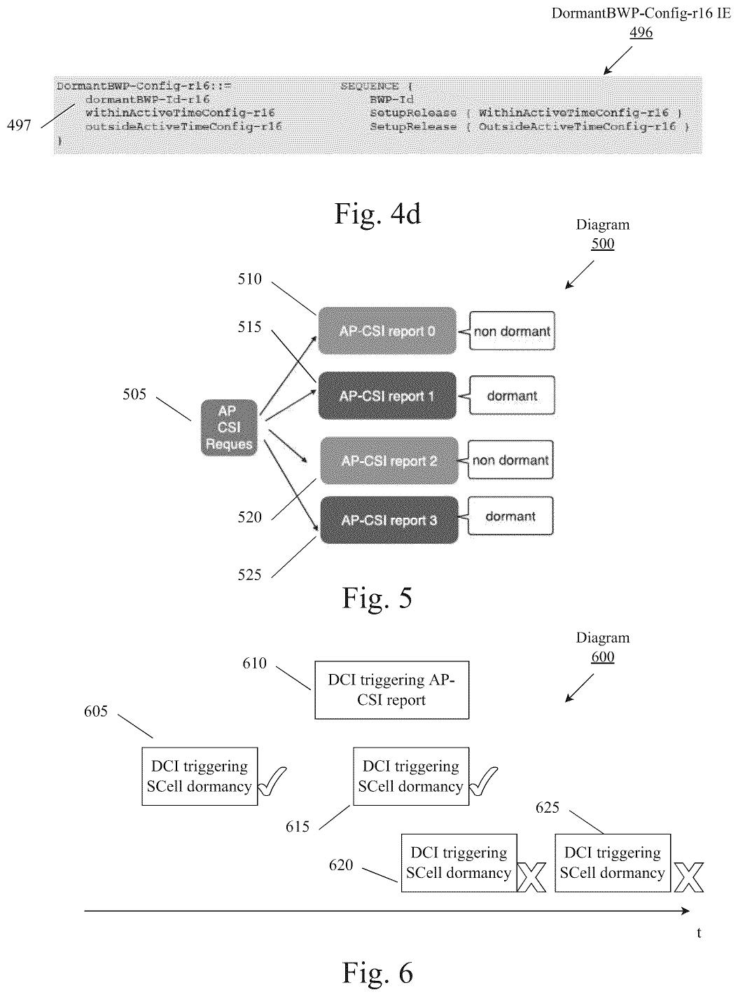

FIG. 6 shows a diagram 600 for a timeline restriction between the DCI triggering/modifying SCell dormancy relative to the DCI triggering an AP-CSI report according to various exemplary embodiments.

In this example, a first DCI 605 triggering SCell dormancy is received earlier than a second DCI 610 triggering the AP-CSI report. Thus, the first DCI 605 is valid and the SCell dormancy switch is handled before the AP-CSI report triggering of the second DCI 610. The last symbol of a third DCI 615 triggering SCell dormancy is received earlier than a last symbol of the second DCI 610 triggering the AP-CSI report. Thus, the third DCI 605 is valid and the SCell dormancy switch is handled before the AP-CSI report triggering of the second DCI 610.

The last symbol of a fourth DCI 620 triggering SCell dormancy is received later than the last symbol of the second DCI 610 triggering the AP-CSI report, and a fifth DCI 625 triggering SCell dormancy is received later than second DCI 610 triggering the AP-CSI report. Thus, the fourth DCI 620 and the fifth DCI 625 are not applied prior to handling the AP-CSI report triggering of the second DCI 610.

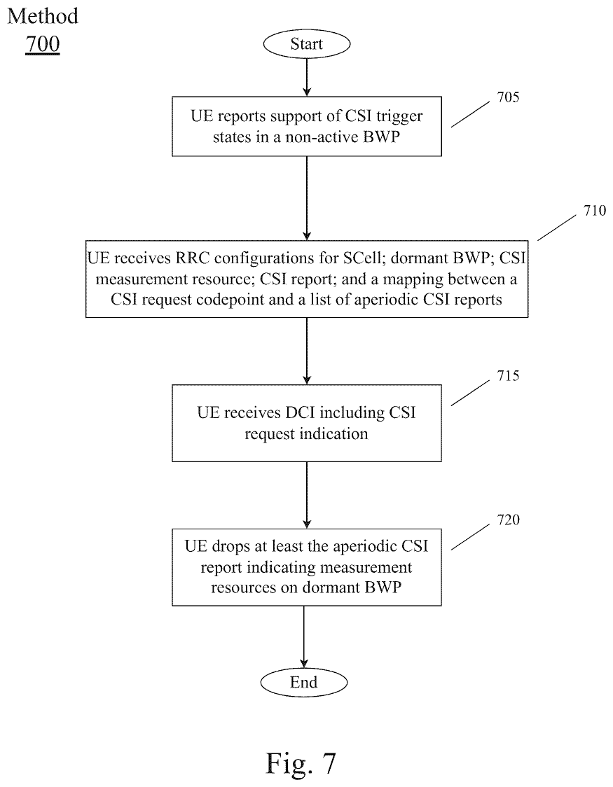

FIG. 7 shows a method 700 for handling an aperiodic CSI report configuration and/or triggering on a dormant BWP according to various exemplary embodiments. In this example, it is assumed that no RRC configuration restrictions are imposed for the measurement resources of an aperiodic CSI report configuration, and any aperiodic CSI report configurations for a measurement resource on a dormant BWP are presumed to be valid.

In 705, the UE reports to the network its support of CSI trigger states in a non-active BWP. As described above, the existing capability (csi-TriggerStateNon-ActiveBWP-r16) can be used. In some embodiments, the existing capability can also indicate support of selective aperiodic CSI report dropping when one or more of the triggered aperiodic CSI reports are in a dormant BWP and others are in a non-dormant BWP, where only the triggered aperiodic CSI reports in the dormant BWP are dropped and the triggered aperiodic CSI reports in the non-dormant BWP are transmitted. In other embodiments, a new capability is used to indicate this support of AP-CSI measurements on the non-dormant BWP when the triggering includes an AP-CSI report on the dormant BWP. This capability can be reported as: per UE; per UE with FR1/FR2 differentiation; per UE with licensed/unlicensed differentiation; per UE with NTN/non-NTN differentiation; per band; or per band combination (BC).

In 710, the UE receives RRC configurations for: an SCell (ServingCellConfig); a dormant BWP (dormantBWP-Config-r16); at least one CSI measurement resource (CSI-ResourceConfig); at least one aperiodic CSI report (CSI-ReportConfig); and a mapping between a CSI request codepoint and a list of aperiodic CSI reports (CSI-AperiodicTriggerStateList). The SCell configuration indicates the dormant BWP and the SCell is the dormant SCell. The (at least one) aperiodic CSI report indicates the (at least one) CSI measurement resource. The (at least one) CSI measurement resource indicates the BWP ID of the dormant BWP. The (at least one) aperiodic CSI report is included in the list of aperiodic CSI reports triggered by the CSI request codepoint.

In this example, this configuration is presumed to be valid. In alternative embodiments, as described above, the network can be restricted from configuring the CSI measurement resource indicating the dormant BWP in the aperiodic CSI report. This restriction may apply for only CMR or may be extended to IMR (including NZP and/or ZP). The UE receiving such a configuration is not expected to handle the aperiodic CSI report configuration. If the dormant BWP is configured/modified after handling the (at least one) aperiodic CSI report configuration, then the UE can deactivate all aperiodic CSI reports having measurement resources in the (new) dormant BWP.

Assuming the validity of the RRC configuration, the UE applies the configuration and the method proceeds to 715.

In 715, the UE receives a DCI including a CSI request indication for triggering a list of aperiodic CSI reports including the (at least one) configured aperiodic CSI report. The codepoint of the CSI request is mapped to the list of (up to 16) aperiodic CSI reports.

It is noted that, if another DCI indicating an SCell dormancy switch is received prior to the DCI including the CSI request indication, or if the last symbol of the DCI indicating the SCell dormancy switch is received prior to the last symbol of the DCI including the CSI request indication, the UE handles the SCell dormancy switch prior to handling the CSI request indication.

In This Example, the List of Aperiodic CSI Reports includes at least one aperiodic CSI report indicating a measurement resource on the dormant BWP and at least one aperiodic CSI report indicating a measurement resource on the non-dormant BWP.

In 720, the UE drops at least the aperiodic CSI report(s) indicating measurement resources on the dormant BWP. In some embodiments, e.g., when selective aperiodic CSI report dropping is not supported, the UE can drop all of the aperiodic CSI reports including those on the non-dormant BWP. If selective aperiodic CSI report dropping is supported, the UE can drop only the aperiodic CSI report(s) indicating measurement resources on the dormant BWP and can transmit the aperiodic CSI reports indicating measurement resources on the non-dormant BWP.

As described above, the step 720 can be extended to aperiodic CSI reports indicating measurement resources on any BWP of the dormant SCell.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving a secondary serving cell (SCell) configuration indicating a dormant bandwidth part (BWP) and a dormant BWP configuration associating the dormant BWP with a BWP identifier (ID);
receiving a channel state information (CSI) resource configuration for a measurement resource associated with the BWP ID of the dormant BWP;
receiving a CSI report configuration for a CSI report, the CSI report configuration indicating the CSI resource configuration for the measurement resource associated with the BWP ID of the dormant BWP; and
either not handling or ignoring at least the CSI resource configuration for the measurement resource associated with the BWP ID of the dormant BWP.

2. The processor of claim 1, wherein the measurement resource is for channel measurement resources (CMR), wherein the operations further comprise:
not handling the CSI report configuration when the CMR is associated with the BWP ID of the dormant BWP.

3. The processor of claim 1, wherein the measurement resource is for either zero power interference measurement resources (ZP-IMR) or non-zero power interference measurement resources (NZP-IMR), wherein the operations further comprise:
not handling the CSI report configuration when the ZP-IMR or NZP-IMR is associated with the BWP ID of the dormant BWP.

4. The processor of claim 1, wherein the measurement resource is for either zero power interference measurement resources (ZP-IMR) or non-zero power interference measurement resources (NZP-IMR) and a further measurement resource in the CSI report configuration associated with a further BWP ID of a non-dormant BWP is for channel measurement resources (CMR), wherein the operations further comprise:
not handling the CSI report configuration when the ZP-IMR or NZP-IMR is associated with the BWP ID of the dormant BWP even when the CMR is associated with the further BWP ID of the non-dormant BWP.

5. The processor of claim 1, wherein the measurement resource is for either zero power interference measurement resources (ZP-IMR) or non-zero power interference measurement resources (NZP-IMR) and a further measurement resource in the CSI report configuration associated with a further BWP ID of a non-dormant BWP is for channel measurement resources (CMR), wherein the operations further comprise:
handling the CSI report configuration when the ZP-IMR or NZP-IMR is associated with the BWP ID of the dormant BWP and the CMR is associated with the further BWP ID of the non-dormant BWP;
ignoring the CSI resource configuration for the ZP-IMR or NZP-IMR associated with the BWP ID of the dormant BWP; and
generating an aperiodic CSI report including CSI for the CMR associated with the further BWP ID of the non-dormant BWP.

6. The processor of claim 1, wherein the operations further comprise:
receiving a further dormant BWP configuration associating the dormant BWP with a further BWP ID; and
deactivating any CSI reports indicating a further CSI resource configuration for further aperiodic measurement resources associated with the further BWP ID of the dormant BWP.

7. A processor of a base station configured to perform operations comprising:
generating, for transmission to a user equipment (UE), a secondary serving cell (SCell) configuration indicating a dormant bandwidth part (BWP) and a dormant BWP configuration associating the dormant BWP with a BWP identifier (ID);
generating, for transmission to the UE, a channel state information (CSI) resource configuration for an aperiodic measurement resource; and
generating, for transmission to the UE, a CSI report configuration for a CSI report, the CSI report configuration indicating the CSI resource configuration for the aperiodic measurement resource,
wherein the base station is restricted from configuring the CSI report with the aperiodic measurement resource associated with the BWP ID of the dormant BWP, or expects the UE to either not handle or ignore at least the CSI resource configuration if the aperiodic measurement resource is associated with the BWP ID of the dormant BWP.

8. The processor of claim 7, wherein the aperiodic measurement resource is for channel measurement resources (CMR), wherein the base station is restricted from configuring an aperiodic CSI report when the CMR is associated with the BWP ID of the dormant BWP.

9. The processor of claim 7, wherein the aperiodic measurement resource is for either zero power interference measurement resources (ZP-IMR) or non-zero power interference measurement resources (NZP-IMR), wherein the base station is restricted from configuring the CSI report when the ZP-IMR or NZP-IMR is associated with the BWP ID of the dormant BWP.

10. The processor of claim 7, wherein the aperiodic measurement resource is for either zero power interference measurement resources (ZP-IMR) or non-zero power interference measurement resources (NZP-IMR) and a further measurement resource in the CSI report configuration associated with a further BWP ID of a non-dormant BWP is for channel measurement resources (CMR), wherein the base station is restricted from configuring the CSI report configuration when the ZP-IMR or NZP-IMR is associated with the BWP ID of the dormant BWP even when the CMR is associated with the further BWP ID of the non-dormant BWP.

11. The processor of claim 7, wherein the aperiodic measurement resource is for either zero power interference measurement resources (ZP-IMR) or non-zero power interference measurement resources (NZP-IMR) and a further measurement resource in the CSI report configuration associated with a further BWP ID of a non-dormant BWP is for channel measurement resources (CMR), wherein the base station expects the UE to handle the CSI report configuration when the ZP-IMR or NZP-IMR is associated with the BWP ID of the dormant BWP and the CMR is associated with the further BWP ID of the non-dormant BWP and ignore the CSI resource configuration for the ZP-IMR or NZP-IMR associated with the BWP ID of the dormant BWP.

12. A processor of a user equipment (UE) configured to perform operations comprising:
receiving a secondary serving cell (SCell) configuration indicating a dormant bandwidth part (BWP) and a dormant BWP configuration associating the dormant BWP with a BWP identifier (ID);
receiving a channel state information (CSI) resource configuration for a measurement resource associated with the BWP ID of the dormant BWP or a further BWP ID of a non-dormant BWP on the SCell;
receiving a CSI report configuration for an aperiodic CSI report, the CSI report configuration indicating the CSI resource configuration for the measurement resource associated with the BWP ID of the dormant BWP or the further BWP ID of the non-dormant BWP on the SCell;
receiving a CSI request configuration mapping a CSI request codepoint to a list of aperiodic CSI reports including the aperiodic CSI report;
receiving a downlink control information (DCI) including the CSI request codepoint triggering execution of the list of aperiodic CSI reports; and
either not handling the triggering, or handling the triggering and dropping at least the aperiodic CSI report including the measurement resource associated with the BWP ID of the dormant BWP or the further BWP ID of the non-dormant BWP on the SCell.

13. The processor of claim 12, wherein the list of aperiodic CSI reports includes the aperiodic CSI report associated with the dormant BWP and further includes at least one further aperiodic CSI report associated with a non-dormant BWP, wherein the operations further comprise:
not handling the triggering when the aperiodic CSI report associated with the dormant BWP is triggered even when the at least one further aperiodic CSI report associated with the non-dormant BWP is triggered by the DCI.

14. The processor of claim 12, wherein the list of aperiodic CSI reports includes the aperiodic CSI report associated with the dormant BWP or the non-dormant BWP on the SCell and further includes at least one further aperiodic CSI report associated with a non-dormant BWP not on the SCell, wherein the operations further comprise:
handling the triggering of the at least one further aperiodic CSI report associated with the non-dormant BWP not on the SCell even when the aperiodic CSI report associated with the dormant BWP or the non-dormant BWP on the SCell is triggered by the DCI.

15. The processor of claim 14, wherein the operations further comprise:
dropping each aperiodic CSI report triggered by the DCI regardless of whether the respective CSI reports are associated with the dormant BWP or the non-dormant BWP on the SCell or the non-dormant BWP not on the SCell.

16. The processor of claim 14, wherein the operations further comprise:
dropping only the aperiodic CSI report associated with the dormant BWP or the non-dormant BWP on the SCell triggered by the DCI; and
generating the at least one further aperiodic CSI report associated with the non-dormant BWP not on the SCell.

17. The processor of claim 12, wherein the operations further comprise:
indicating support of a feature for dropping aperiodic CSI reports in the dormant BWP and transmitting aperiodic CSI reports in the non-dormant BWP.

18. The processor of claim 17, wherein the support for the feature is indicated in a UE capability for handling a trigger state in a non-active BWP.

19. The processor of claim 17, wherein the support for the feature is indicated in a new UE capability.

20. The processor of claim 19, wherein the new UE capability has a prerequisite of supporting SCell dormancy.

21-22. (canceled)
